(19) United States
(12) Patent Application Publication
(10) Pub. No.: US 2026/0312341 A1
(43) Pub. Date: Oct. 8, 2026

(54) CONNECTOR AND SYSTEM

(71) Applicant: HARTING International Innovation AG, Biel (CH)

(72) Inventor: Fabrizia Ghezzo, Biel (CH)

(73) Assignee: HARTING International Innovation AG, Biel (CH)

(21) Appl. No.: 19/481,323

(22) PCT Filed: May 8, 2023
(86) PCT No.: PCT/EP2023/062125

§ 371 Date: Nov. 4, 2025

(51) Int. Cl. H01R 13/66; B61L 15/00; B61L 23/04; G01H 1/00; H01R 13/50; H01R 13/73

(52) U.S. Cl. CPC H01R 13/6683; B61L 15/0036; B61L 23/045; G01H 1/00; H01R 13/50; H01R 13/73; H01R 2201/26

(57) ABSTRACT

The invention refers to a connector (33). A connector (33) may be configured for transferring power and/or for transmitting a signal in a train (1), particularly in a train coach (32), further particularly between two train coaches (32), comprising at least one electronic assembly (34), wherein the electronic assembly (34) comprises:—at least one sensor (35) configured to monitor at least one physical parameter for determining a track condition; and—at least one circuit board (36) connected to the at least one sensor (35); wherein the at least one electronic assembly (34) is positioned at a connector housing (12) and/or positioned inside a connector housing (12).

The invention relates to a connector configured for transferring power and/or for transmitting a signal in a train. The invention relates to a train or train coach comprising such a connector. The invention relates to a use of such a connector and/or such a train and/or such a train coach. The invention relates to a method of monitoring.

### PRIOR ART

Given the need for safety and reliability in the transportation industry and especially in the railway industry, maintenance is done quite often on trains (for all components) and on rail lines. Inspections and tests are frequently done e.g., on a monthly and/or on a yearly basis. Today, there exist a huge number of sensors distributed on a train and on the rail lines (optic sensors for instance), which are supposed to monitor the status of the line itself e.g., on a national level (Germany for example) or on a regional, international level (European Union for example). The distribution of sensors along a network of thousands of kilometers in a national territory is demanding and expensive. For the presence of severe damage on the line different methods are used e.g., sending ultrasounds to detect faults. These faults are already progressed and may already lead to severe accidents. The applicant is aware of these safety risks and operates with all due care to prevent those accidents and implements state of the art safety protocols, equipment and methods.

### Problem to Be Solved

The present safety protocols, equipment and methods shall be further improved to further reduce safety risks. State-of-the-art maintenance of rail lines and train performance is expensive and demanding. It is an objective to reduce the resources necessary to perform those maintenance steps, to follow the safety protocols and to operate the respective equipment.

Furthermore, the costs of the equipment shall be reduced. Also, the legal demands in registering the respective equipment resulting from the implementation of the equipment has to be followed, but the costs associated with it shall be reduced based on the equipment to be implemented.

### Embodiment

The problem is solved by a connector, particularly a smart connector, according to claim 1. The problem is solved by a train or train coach according to claim 8. The problem is solved by a use of a respective connector and/or a respective train and/or a respective train coach, according to claim 9. The problem is solved by a method according to claim 10.

According to an aspect of the invention, the problem is solved by a connector with the features according to claim 1.

A connector, particularly a smart connector, may be configured for transferring power and/or for transmitting a signal in a train. Particularly the connector may transfer power and/or transmit a signal in a train coach, further particularly between two train coaches. The connector may comprise at least one electronic assembly. The electronic assembly may comprise at least one sensor configured to monitor at least one physical parameter for determining a track configuration. The electronic assembly may comprise at least one circuit board connected to the at least one sensor. The at least one electronic assembly may be positioned at a connector housing and/or positioned inside a connector housing. This assembly of the connector used for transferring power and/or transmitting a signal to function as a monitoring device allows to implement safety protocols and methods to further improve safety risk reduction based on this equipment. This reduces costs of equipment and reduces the demands of implementing the equipment as well as operating it.

Therefore, the resources necessary to perform those maintenance steps, to follow the safety protocols and to operate the respective equipment are further reduced. Furthermore, the costs of the equipment are reduced. Also, the legal demands in registering the respective equipment resulting from the implementation of the equipment may be followed, but the costs associated with it may be reduced as equipment is upgraded that may already be compliant with legal provisions of railway administration.

The connector may be any connector associated with transferring power in a train, in a train coach and/or between train coaches. The connector may be any connector associated with transmitting signals in a train, in a train coach and/or between train coaches. In particular, the connector comprises a housing that is suitable to carry the load of a respective electronic assembly and/or to house the electronics assembly. In embodiments, connectors which are already accepted by railway and transportation administrations can be used and can be upgraded. Therefore, it may be feasible to reduce the administration resources as equipment is implemented that may already carry an approval for use in a respective train and only the upgraded version could have to be approved. This may reduce the respective time frame necessary for approval and may therefore reduce the costs associated with this approval.

Furthermore, the power transferred in the connector may at least to some extent be used to power the sensor and/or the circuit board to operate. Additionally or alternatively, battery devices may be charged (also re-charged) which may operate the sensor and/or the circuit board, at least to some extent.

The signal transferred in the connector may be related to the physical parameter monitored for determining a track configuration. Alternatively or additionally, the signal may be different from the physical parameter monitored for determining a track configuration.

Monitoring at least one physical parameter for determining a track configuration may refer to monitoring how smoothly the train travels on the rails. This may allow for detecting wear and minor defects that are not affecting the transit but are a source of concern because at a certain point in the future they can become critical. Unbalances, different accelerations, and vibrations along the line can indicate some issues in certain points along the line itself.

Sensors for monitoring unbalances, different accelerations and/or vibrations may be mounted on the train. Trains travel constantly along the national (regional and international) network and can operate as a mean to scan for the status of the lines and collect information to prevent having the growth of defects in large damage with potential high accident risk.

The smart connector contributes to the area of preventive maintenance for rail lines and trains performance. Preventive maintenance means in the context given here that traditional maintenance methods, based on a fixed schedule, are now replaced by “maintenance when needed”. This type of maintenance may require the use of “intelligent systems” capable to monitor the status of a component/product/system and may request maintenance only when it is needed and where it is needed. This concept may be applied to all energy and transportation sectors where cost of maintenance is very high and has high incident on the final cost for the user/consumer. Based on the device described herein, those may be reduced and may be optimized.

The proposed smart connector may not only function as a traditional connector (providing power and data transfer) but may also function as a monitoring device for rail lines and trains performance.

The circuit board may be any board associated with powering and operating a respective sensor as described here and throughout the description. The respective circuit board may be a circuit board for a PCB-connector. The circuit board may run a respective computer storage device e.g., an SSD and/or a flash drive. The circuit board may run a computer machine core unit e.g., a CPU for allowing at least running initial components of a computer-implemented method for monitoring and/or analyzing the collected data for determining a track configuration.

In particular, the data may (only) be saved at least temporarily according to some embodiments in a smart connector (or a CPU therein). The smart connector may transfer at-least-temporarily-stored data at some point in time—particularly a defined point in time e.g., based on a trigger to transfer the data—to a central (computer) unit where the analysis may be performed. Therein a central analysis unit may particularly be integrated inside the train. In this sense the data may be collected and/or transferred, the analysis may be performed by a separate system.

According to some embodiments, the amount of data which can be saved in a miniaturized smart board (circuit board) inside a (smart) connector can be managed: Frequency for detecting signals can be quite high, and the train will travel for thousands of kilometers. Connectors according to some of the described embodiments may transfer power. In some described embodiments these connectors may be hybrid—transferring data and power—so in one of these embodiments, the data may temporarily be stored in the smart connector and when something significant happens (abnormal deviation from a calibrated vibrations trend while the train is moving), can be transferred to a system for analyses. In other words, certain amount of data may be buffered. Excessive data may be deleted when nothing significant happens to empty the buffer.

A track configuration may be any configuration that may lead to further derogation of the state of the rails, of the track bed and/or of any other state of operation of the respective track at a certain moment in time at a given place (where the train may pass at the given time) from given standard and/or minimal parameters. The track configuration may imprint on the operation mode of the train and allow for the respective preventive maintenance as it is described throughout the description.

The electronic assembly may further comprise the electronics necessary for transferring the power and/or for transmitting the signals. In other embodiments, the electronic assembly may operate completely independent from those.

According to another aspect, the sensor is either of a vibration sensor or an acceleration sensor. This allows to monitor at least one of two physical parameters that may be associated with a track configuration. This may allow monitoring how smoothly the train travels on the rails. This may allow for detecting wear and minor defects that may not affect the transit (at least yet) but may be a source of concern because at a certain point in the future they can become critical. Unbalances, different accelerations, and vibrations along the line can indicate some issues in certain points along the line itself. These unbalances may result in different accelerations e.g., having at least one acceleration component perpendicular to the vector of the travel direction. The unbalances may result in vibration which are carried over to the connector.

The connector housing may be optimized to function as some sort of receptive resonator to at least partially boost some vibration and/or acceleration components to enhance the detection of the sensor.

According to some embodiments, the configuration of at least one railroad switch may be monitored and/or analyzed. This may reduce the risk of accidents at points, where the train may change direction and may move from one track to another. At this point there may be “movable” tracks that may force the train in a new direction. The wear on these short “interconnecting” tracks may be very high because the weight of a coach suddenly stays on a few meter long tracks. These parts may often be inspected and changed. It may reduce the risks of accidents, but also the resources potentially used to be able to predict when these parts need to be changed.

According to one aspect, the electronic assembly may be positioned at an external surface of the connector housing, covered by a housing of another connector, particularly a parallel connector. This allows to use space particularly between two parallel connectors.

The parallel connectors may be identical connectors or different connectors. Both connectors may provide protrusions on their exterior surface which are configured such that in case of plugging in the connectors, the protrusions may form a cavity for housing the at least one circuit board and/or the at least one sensor, which may be positioned between the two connectors. In alternative embodiments only one of the two parallel connectors may comprise the protrusions such that the cavity is formed for housing the at least one circuit board and/or the at least one sensor.

The term “parallel connectors” may refer to the connectors pointing in parallel direction e.g., because they are plugged into the same panel of sockets.

Alternatively or additionally, the electronic assembly may be positioned at an external surface of the housing. Therein, the external surface may be facing a wall of a train and/or a train coach.

This wall may be a side wall, particularly between two coaches, the walls particularly facing each other. Alternatively, the wall may be an underbody panel of the train and/or the train coach.

According to an aspect, the exterior surface of the connector may comprise protrusions. Therein, the protrusions may be configured to provide contact between the connector and a wall. Alternatively or additionally the protrusions may be configured to provide contact between the connector and another connector. This allows to build a cavity between the connector carrying the electronic assembly and a place of mounting to for protecting the electronic assembly or parts thereof.

The place of mounting may be e.g., the wall the connector is mounted to. Alternatively or additionally, the connector may be mounted in a connector assembly e.g. in an assembly of several sockets. Therein it may be possible that the connector forms a cavity with a surface of the housing of a neighboring connector to form a protective cavity. In such a cavity it may be possible to isolate the electronic assembly from moisture and/or dust.

In alternative embodiments, the other connector may comprise protrusion in addition to the protrusions of the surface of the connector carrying the electronic assembly. In alternative embodiments, the other connector may comprise protrusion instead of the connector carrying the electronic assembly. Here, the reader's attention is referred to the description of the parallel connectors and the respective surface configuration as described elsewhere in the description. The recasting of text is avoided for matters of conciseness and readability only.

According to another aspect, the housing may comprise a cavity. The electronic assembly may be mounted in the cavity. This cavity may be formed inside of the housing such that access is only possible from the inside of the connector housing. Therefore, the other electronic components (for transferring power and/or for transmitting at least one signal) may be overlaying the respective cavity in a mode of operation and in a fully assembled and/or mounted configuration. In such a configuration the cavity may not be accessible for exchanging the electronics assembly or any part thereof. Here and elsewhere in the description the parts of the electronic assembly may particularly refer to the circuit board and/or the sensor.

In other embodiments, the cavity may be accessible from the outside of the connector housing. In this case the cavity may be referred to as an external cavity. Particularly, the Han® HPR TrainPowerLine (TPL) connector and/or the Han® HPR VarioShell (VarioShell) connector may comprise an external cavity as their internal structure may be packed with conducting components, particularly carrying high currents (high power applications as used in train application at the date of filing and/or the date of priority).

According to one aspect, the housing comprises an opening connecting the external surface and the cavity for inserting the electronic assembly through the opening. In particular, the opening may be different from an opening of the connector to access any other electronics parts, particularly for transferring power and/or for transmitting at least one signal. This allows to access the electronic assembly without opening any other compartment. Therefore, the electronic assembly may be accessed without interfering with the assembly of power lines and/or signal lines. In a matter of use scenario or in a maintenance method, an exchange of the electronic assembly and/or of part thereof may be possible without rearranging the power lines and/or the signal lines.

There may be embodiments of connectors where multiple connectors can be assembled into an external housing (can be referred to as an insulation body), particularly forming a connector assembly, and those connectors that may provide a hybrid solution (current transfer and data transfer), particularly comprising the HARTING modular system. The insulation body may be built in modules and each module may be designed to be able to provide a different function (carry contacts, allows for ethernet cable connection, etc.). The miniaturization described in the description may allow to provide a circuit board with electronics which can be built in a modular shape (simple vertical slot) to fit in the whole modular HARTING system. This may provide the connection to power and data transfer for the electronics. Placing the board may be chosen between the induvial modules of in the connector type.

According to another aspect, the connector can be connected to a surface below a coach. The surface below a train and/or a train coach can be an underbody panel of the train and/or the train coach as already described elsewhere in this description. It is referred to these parts of the description without recasting the respective parts for matters of conciseness and readability.

According to an independent aspect the problem is solved by a train and/or a train coach comprising a connector as described throughout the description. The aspects, features, effects and advantages described with respect to the connector may also describe and specify the train and/or the train coach. Furthermore, any aspects that refer to the train and/or train coach, the respective features, effects and advantages may describe and specify the connector.

According to an independent aspect the problem is solved by a use of a train and/or a train coach and/or a connector, particularly as described throughout the description. The aspects, features, effects and advantages described with respect to the connector may also describe and specify the use of the train and/or the train coach and/or the connector. Furthermore, any aspects that refer to the train and/or the train coach and/or the connector, the respective features, effects and advantages described with respect thereto, may describe and specify their particular use, as well as any other method.

According to an independent aspect the problem is solved by a method configured to detect at least a track condition. The method may comprise the step of monitoring at least one physical parameter for determining a track configuration. This may particularly be based either on monitoring and/or determining a vibration or an acceleration e.g., by a connector as described elsewhere in the description, particularly in a train as described elsewhere in the description. The method may comprise the step of analyzing at least one physical parameter and/or a spectrum related to at least one physical parameter to determine the track configuration. The aspects, features, effects and advantages described with respect to the connector, as well as with respect to their particular use, may also describe and specify the method configured to detect at least a track condition. Furthermore, any aspects that refer to the train and/or the train coach and/or the connector and their respective particular use may be specified and described by the respective features, effects and advantages described with respect to this method.

As a summary and in different words, there are several types of connectors that may be used in the rail industry. Some of them may be referred to as heavy duty connectors, among them one could cite the Han® HPR series by HARTING, connectors family, for instance, but the invention is not limited to these. Some of these connectors can be placed underneath the train, particularly in proximity of two coaches that need to be “connected” where power, data etc. can be transferred from one to the next coach. Some others may only be responsible to transfer data. Some of these connectors may be placed very close to the train wheels and in general to the rail lines. “Very close” may refer to the suitability to achieve a maximum in vibration and or acceleration transfer linked to the wheel rail interaction.

According to the embodiments described here and elsewhere throughout the description it is envisioned that a connector is equipped with sensors and/or a board of electronics—referred to as circuit board elsewhere in the description—for acquisition of signals coming from these sensors. The board of electronics and the sensors can be placed inside the connector housing. The board can also be placed on the housing. Miniaturization of electronic components can be such that PCB boards can be designed to allocate microcontrollers, switches, etc. and which can easily be placed inside the housing. The sensors for monitoring the rail lines can comprise sensors through which vibrations and accelerations can be measured, potentially including shock and impact.

The intelligent part of the connector can be the feature contributing to the preventive maintenance described elsewhere throughout the description. It can be linked with a computer program product, which when run on a computer and/or a CPU may allow to perform the steps of a method of monitoring and/or analyzing the respective contributions of the measured at least one physical parameter to potential track conditions.

This way in modern trains, vibrations at the wheels can be monitored. Thus, it is possible to monitor the safety of the wheels and therefore the status of the rail lines without exposing the sensors to the external environment. This can reduce the maintenance requirements of the sensors and can reduce the necessity of frequent replacements. They may also not need dedicated power lines and acquisition systems, where cabling can be a problem (long cables to add to an already quite dense and intricated cabling system underneath the train) and where wireless data transfer may undergo a lot of interference. Using a connector with the respective electronic assembly e.g., at least one sensor and a PCB (miniaturized or flexible) board, where the connector is already transferring power and data, at least a part of the transferred power can be used to power the electronics, particularly while simultaneously transferring data. In embodiments, where there is no possibility to power the electronics this way, a battery pack may be recharged by an energy harvesting system which may be integrated in the solution. In other embodiments, this can be also designed to be the general solution. The system is particularly feasible with current electronics and/or current sensors, and the housing can be designed to allocate the system. The ideal connector that can function as monitoring device which can be designed to host an “intelligent system” for preventive maintenance of rail lines. In some embodiments, the current shape of Han® HPR TrainPowerLine (TPL) connectors and Han® HPR VarioShell (VarioShell) connectors (both as distributed by HARTING on the filing date and/or the date of priority) can be adequate to host this system.

The application of a new intelligent connector to monitor rail lines may comprise the monitoring by using a smart system (sensors and/or board of electronics, as a circuit board and/or a data analysis e.g., based on a computer program product and a particular method) which can be integrated in the connector housing. The integration of the system in the connector housing may save space, may protect the electronics and may allow for a possible efficient monitoring as the TPL connector, for instance being placed underneath the train, particularly underneath a train coach (on an underbody panel of the train and/or the train coach) and in particularly very close (in the sense of close as possible) to as many vibrations and accelerations as possible, where the vibrations and/or accelerations may be due to a not smooth movement of the wheels on the rail lines. The collected data can be transferred through cable or wireless (if the board of electronics is placed on the housing but mounted particularly externally as described elsewhere in the description).

The connector housing can be designed to provide the space—also in form of a cavity and/or an indentation suitable for uptake of a respective electronic assembly—for allocating a board of electronics and at least one sensor, in particular several sensors, for data acquisition. This may allow at least one, in particular all the sensors and the acquisition system to be protected by the housing and/or the cavity from the external environment. Furthermore, there may be no need to use additional “boxes” where the electronics must be stored, increasing the number of components (and the weight) on a train. This also reduces the necessary resources of operating the respective device and/or system and improves a use.

The smart connector can be certified as a new product and the system integrated inside the connector will be subsequently receive the same certification. There may be no need, as for current monitoring systems with sensors distributed underneath a train, that each single sensor and connected detection system to be certified separately, along with any additional sensor that is added to the train for any purpose. Therefore, the technical implementation may result in an improved and speeded up legal admission and approval process as of the legal prerequisites e.g., in Germany, the United States, Japan, China, South Korea and/or the European Union on date of filing and/or the date of priority.

In embodiments of the smart connector at least one of at least one sensor, at least one acquisition system, at least one cable may all be incorporated into the smart connector. This may support minimizing and/or improving organizing the network of cables present in the train. Additionally or alternatively, the sensing system may be protected by the housing. Additionally or alternatively, the sensors may be protected from the outside environment which allows for longer life-time. Additionally or alternatively, the smart connector may comprise an insulation—particularly from rubber material—to insulate the at least one sensor and/or at least one acquisition system. The insulation may form part of a cavity—either internal cavity and/or external cavity—as described elsewhere in the description.

The combination of current electronics and sensors may be integrated into a connector housing for collecting data while the train is in service and based on the accelerations (in three planes x,y,z) and vibration data, particularly extracting useful information on the status of the rail lines. A testing may be based on a HPR/TPL (Han® HPR TrainPowerLine) connector equipped with accelerometers and/or piezoelectric sensors. The HPR/TPL (Han® HPR TrainPowerLine) connector can be mounted on a section of a train coach and can be tested.

In short, a connector housing may present a board (circuit board) for electronics and/or at least one sensor that can detect vibrations and/or accelerations. The data constantly acquired by the at least one sensor may be elaborated by a system that can detect anomalies of movement of the train along the rail lines (larger vibrations or acceleration in a specific direction can point to different movement for the wheels on the rails—small rotation, etc.—and therefore advanced wear or other defects). The system can detect the anomalies and inform a remote station or request a check or maintenance of the rail lines at given coordinates.

An embodiment of the invention is shown in the figures and described in detail in the following. Therein, it is shown in:

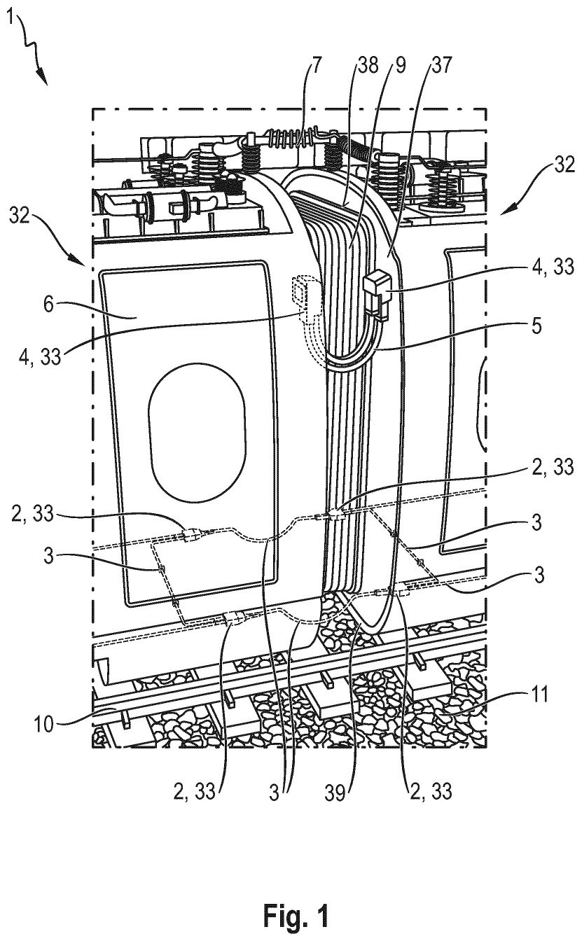

FIG. 1 an embodiment of the train operating on a rail line;

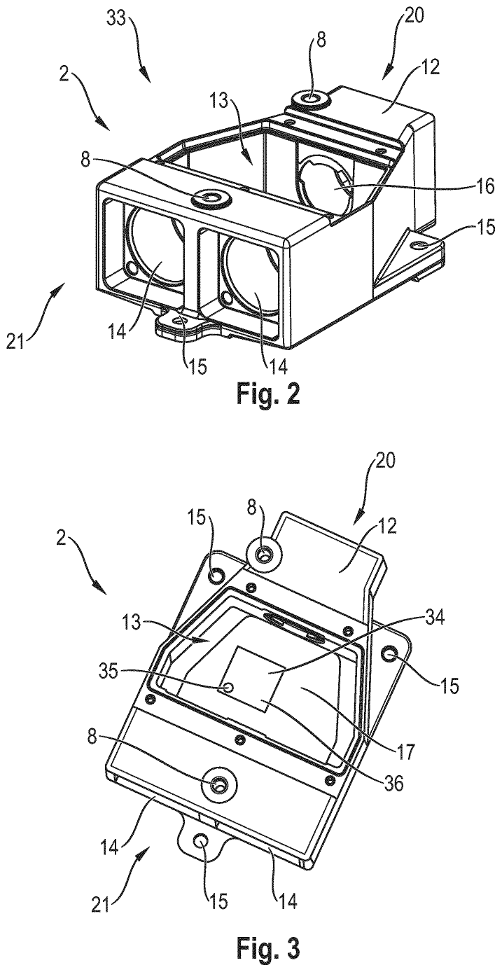

FIG. 2 an embodiment of a connector;

FIG. 3 an embodiment of a connector in top view;

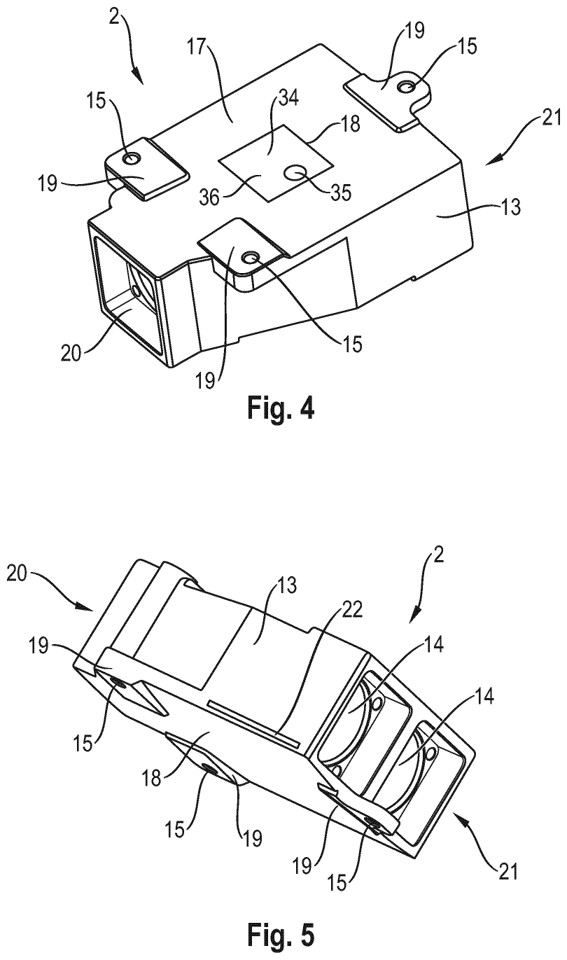

FIG. 4 an embodiment of a connector in bottom view;

FIG. 5 an embodiment of a connector inside view;

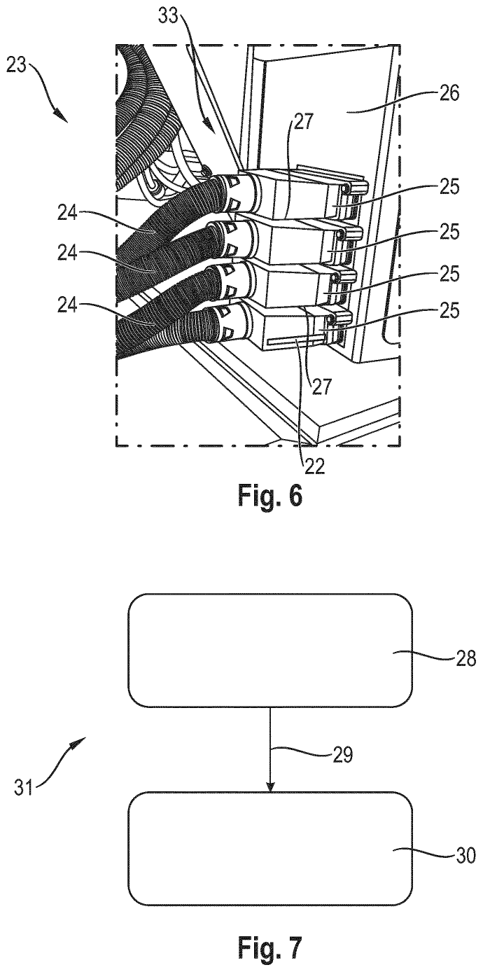

FIG. 6 an embodiment of a connector assembly; and

FIG. 7 an embodiment of a method.

Some of the figures contain simplified, schematic representations. In some cases, identical reference signs are used for the same, but possibly not identical, elements. Different views of the same elements might be scaled differently. Directions such as “left”, “right”, “up” and “down” are to be understood in relation to the respective figure and may vary in the individual representations compared to the object depicted.

FIG. 1 shows an exemplary embodiment of a train 1 operating on a rail line 10. Two connected sections of two coaches 32 are shown in an excerpt of the whole train. The sections from the two coaches each comprise passenger door 6 entries. Between the two coaches 32 and the two sections are particularly linked by a section connection 9. Between the two train coaches 32 power line cables 3 and data cables 5 may cross the gap between the two train coaches 32. The power line cables 3 and/or the data cables may be connected to a smart connector 4 located between the two coaches 32 and/or to smart connectors 2 located underneath the two train coaches 32. High power connections 7 may span a top part of the two coaches 32. The smart connectors 2, 4 may be embodiments of connectors 33 described in the following. Those smart connectors 2, 4 as embodiments of connectors 33 may be capable to monitor 28 at least one physical parameter to determine a track condition.

FIG. 2 shows an exemplary embodiment of a connector 33, particularly a connector housing 12. The exemplary embodiment comprises a front facet 20 of a smart connector with a single socket 16 and a backend facet of a smart connector with two sockets 14.

The connector 33 comprises a connector interior 13 for placing the respective power transfer electronics and/or the data transmission electronics, which are not shown herein. Screw threads 8 may be used to connect those electronics and the connector housing 12. The connector interior 13 may comprise an indentation 17 that functions as a cavity to hold the respective circuit board 36 which can comprise at least one sensor 35, particularly forming an electronic assembly 34. The sensor 35 may be either of a vibration sensor or an acceleration sensor.

Furthermore, the connector housing 12 may comprise screw holes 15 to attach the connector housing 12 e.g., to a wall 37. As shown in FIG. 1, the wall 37 may be a side wall 38 and/or an underbody panel 39. Attachment of the connector housing 12 may be directly and/or indirectly e.g., via intermediate structures such as a base plate (nor shown) and/or an isolation plate (not shown).

FIG. 3 shows a top view of the embodiment shown in FIG. 2. The connector 33 can be configured for transferring power and/or for transmitting a signal in a train 1, particularly in a train coach 32, further particularly between two train coaches 32, as shown in FIG. 1. The connector 33 can comprise at least one electronic assembly 34. Therein, the electronic assembly 34 can comprise at least one sensor 35 particularly configured to monitor at least one physical parameter for determining a track condition. Additionally and/or alternatively at least one circuit board 36 can be connected to the at least one sensor 35 to form the electronic assembly 34. The at least one electronic assembly 34 can be positioned at a connector housing 12, particularly to an external surface as shown in FIG. 4. Additionally or alternatively at least one electronic assembly 34 can be positioned inside a connector housing 12 as shown in FIG. 3.

In FIG. 4, an exemplary embodiment is shown, wherein the at least one electronic assembly 34 can be positioned at a connector housing 12, particularly to an external surface. A cavity 17 is formed by positioning the connector housing 12 to a wall 37 via screwing screws through screw holes 15. Protrusions 19 can lead to a spatial difference between the external surface and the wall 37 surface. In this cavity 17 the electronic assembly 34 can be placed. This configuration may be referred to as a sandwich configuration. Therein, the electronic assembly may be protected from external influences e.g., weather conditions. The circuit board 36 may be a PCB board which is placed in the respective PCB board location 18.

FIG. 5 shows another exemplary embodiment in a side view of a connector housing 12. The connector housing 12 comprises an opening 22 connecting the external surface and the cavity 17 for inserting the electronic assembly 34 through the opening 22. This way the electronics assembly can be transferred to a cavity 17 which is located inside the connector housing 12 e.g., as shown in FIG. 3.

FIG. 6 shows an embodiment of a connector assembly 23 at a socket assembly 26. The respective connector housings 25 may comprise an electronic assembly 34 which can be positioned at an external surface of the connector housing 25. The electronic assembly may be covered by a connector housing 25 of another connector, particularly a parallel connector. The connectors shown here can be referred to as parallel connectors as they point into the same direction when plugged into the socket assembly 26. Cables are bundled by a cable assembly 24.

The connectors 33 from the connector assembly 23 comprise connector housings 25 with external surfaces 27. These external surfaces 27 of the connector housing 25 may comprise protrusions 19 (here not visible). The protrusions 19 can be configured to provide contact between the connectors, particularly the connector housings 25 between the individual connectors 33, particularly their connector housings 25. Thus, an external cavity 17 may be formed where the electronic assembly 34 may be placed.

Alternatively or additionally internal cavities (not visible) may be provided in the connector housings 25. Therein an opening 22 may be provided to allow for inserting an electronic assembly into a connector housing 25.

FIG. 7 shows an exemplary embodiment of a method 31 configured to detect at least a track condition. The method 31 may comprise the step of monitoring 28 at least one physical parameter for determining a track condition, particularly either of a vibration or an acceleration. The monitoring 28 is particularly performed by a connector 33 as described elsewhere in the description, particularly in a train 1 or train coach 32 as described elsewhere in the description. The data which is monitored may be transferred 29 e.g., to a server or an analysis unit e.g., a CPU for running a computer-program product for analyzing data and/or controlling a respective method. The method 31 may comprise the step of analyzing 30 the at least one physical parameter and/or a spectrum related to at least one physical parameter to determine the track condition.

The features, functions, effects and advantages of the connector, the train and/or the train coach set out in this description, each with respect to different aspects and embodiments, as well as with regard to processes that may describe a method, may be considered in isolation from the relationships and combinations described herein and used to identify the connector, the train, the train coach, the respective use thereof and/or any method, i.e. in particular crossing category boundaries.

### REFERENCE SIGNS

1 train operating on a rail line
2 smart connector underneath a train coach
3 power line cable
4 smart connector between two coaches
5 data cable
6 train coach door
7 high power connection
8 screw thread
9 section connection
10 rail line
11 track bed
12 connector housing
13 connector interior
14 sockets
15 screw holes
16 socket
17 cavity/indentation
18 PCB board location
19 protrusions
20 front facet of a smart connector
21 back facet of a smart connector
22 opening
23 connector assembly
24 cable assembly
25 connector housing
26 socket assembly
27 external surface
28 method step of monitoring data
29 method step of transferring the monitored data
30 method step of analyzing the monitored data
31 method configured to detect at least a track condition
32 train coach
33 connector
34 electronic assembly
35 sensor
36 circuit board
37 wall
38 side wall
39 underbody panel

1. A connector configured for transferring power and/or for transmitting a signal in a train, particularly in a train coach, further particularly between two train coaches, comprising at least one electronic assembly, wherein the electronic assembly comprises:
at least one sensor configured to monitor at least one physical parameter for determining a track condition; and
at least one circuit board connected to the at least one sensor;
wherein the at least one electronic assembly is positioned at a connector housing and/or positioned inside a connector housing.

2. The connector according to claim 1, wherein the sensor is either of a vibration sensor or an acceleration sensor.

3. The connector according to either claim 1, wherein the electronic assembly is positioned at an external surface of the connector housing, covered by a connector housing of another connector, particularly a parallel connector; and/or
wherein the electronic assembly is positioned at an external surface of the connector housing and wherein the external surface is facing a wall, particularly side wall or an underbody panel of the train and/or the train coach.

4. The connector according to Claim 1, wherein the exterior surface of the connector housing comprises protrusions and wherein the protrusions are configured to provide contact between the connector, particularly the connector housing, and a wall and/or between the connector, particularly the connector housing, and another connector, particularly the other connector housing.

5. The connector according to Claim 1, wherein the connector housing comprises a cavity, wherein the electronic assembly is mounted in the cavity.

6. The connector according to Claim 1, wherein the connector housing comprises an opening connecting the external surface and the cavity for inserting the electronic assembly through the opening.

7. The connector according to Claim 1, wherein the connector is connected to a surface underneath the train and/or the train coach.

8. Train or train coach comprising a connector according to Claim 1.

9. Use of a connector according to claim 1 for detecting at least one parameter of a track condition; and/or
use of a train or train coach according to claim 8 for detecting at least one parameter of a track condition.

10. Method configured to detect at least a track condition comprising the steps:
monitoring at least one physical parameter for determining a track condition, particularly either of a vibration or an acceleration, by a connector Claim 1 in a train or train coach of claim 8;
analyzing the at least one physical parameter and/or a spectrum related to at least one physical parameter to determine the track condition.
